(19) United States
(12) Patent Application Publication
(10) Pub. No.: US 2023/0360638 A1
(43) Pub. Date: Nov. 9, 2023

(54) METHOD OF PROCESSING SPEECH INFORMATION, METHOD OF TRAINING MODEL, AND WAKE-UP METHOD

(71) Applicant: Beijing Baidu Netcom Science Technology Co., Ltd., Beijing (CN)

(72) Inventors: Saisai ZOU, Beijing (CN); Lei JIA, Beijing (CN); Haifeng WANG, Beijing (CN)

(21) Appl. No.: 18/221,593

(22) Filed: Jul. 13, 2023

(30) Foreign Application Priority Data
Jul. 15, 2022 (CN) 202210839668.X

(51) Int. Cl. G10L 15/02; G10L 15/14

(52) U.S. Cl. CPC G10L 15/02; G10L 15/14; G10L 2015/027

(57) ABSTRACT

A method of processing a speech information, a method of training a speech model, a speech wake-up method, an electronic device, and a storage medium are provided, which relate to a field of artificial intelligence technology, in particular to fields of human-computer interaction, deep learning and intelligent speech technologies. A specific implementation solution includes: performing a syllable recognition on a speech information to obtain a posterior probability sequence for the speech information, where the speech information includes a speech frame sequence, the posterior probability sequence corresponds to the speech frame sequence, and each posterior probability in the posterior probability sequence represents a similarity between a syllable in a speech frame matched with the posterior probability and a predetermined syllable; and determining a target peak speech frame from the speech frame sequence based on the posterior probability sequence.

### CROSS-REFERENCE TO RELATED APPLICATION(S)

This application claims the benefit of Chinese Patent Application No. 202210839668.X filed on Jul. 15, 2022, the whole disclosure of which is incorporated herein by reference.

### TECHNICAL FIELD

The present disclosure relates to a field of artificial intelligence technology, in particular to fields of human-computer interaction, deep learning and intelligent speech technologies. Specifically, the present disclosure relates to a method of processing a speech information, a method of training a speech model, a speech wake-up method, an electronic device, and a storage medium.

### BACKGROUND

A speech interaction is a natural way of a human interaction. With a continuous development of the artificial intelligence technology, it has been achieved that a machine may understand a human speech, understand an inherent meaning of a speech, and give a corresponding feedback. In these operations, a speed of response to wake-up, a difficulty of wake-up, an accurate understanding of semantics, and a speed of giving feedback are all factors that affect a smoothness of the speech interaction.

### SUMMARY

The present disclosure provides a method of processing a speech information, a method of training a speech model, a speech wake-up method, an electronic device, and a storage medium.

According to an aspect of the present disclosure, a method of processing a speech information is provided, including: performing a syllable recognition on a speech information to obtain a posterior probability sequence for the speech information, where the speech information includes a speech frame sequence, the posterior probability sequence corresponds to the speech frame sequence, and each posterior probability in the posterior probability sequence represents a similarity between a syllable in a speech frame matched with the posterior probability and a predetermined syllable; and determining a target peak speech frame from the speech frame sequence based on the posterior probability sequence.

According to another aspect of the present disclosure, a method of training a speech model is provided, including: training a syllable recognition model by using a target peak speech frame and a syllable label matched with the target peak speech frame, so as to obtain a trained syllable recognition model, where the target peak speech frame is obtained by using the method of processing the speech information as described above.

According to another aspect of the present disclosure, a speech wake-up method is provided, including: inputting a speech to be recognized into a syllable recognition model to obtain a syllable recognition result; and determining whether the speech to be recognized is a correct wake-up speech according to the syllable recognition result, where the syllable recognition model is obtained by using the method of training the speech model as described above.

According to another aspect of the present disclosure, an electronic device is provided, including: one or more processors; and a memory for storing one or more programs, where the one or more programs are configured to, when executed by the one or more processors, cause the one or more processors to implement the methods described in the present disclosure.

According to another aspect of the present disclosure, a computer readable storage medium having computer executable instructions therein is provided, and the instructions are configured to, when executed by a processor, cause the processor to implement the methods described in the present disclosure.

It should be understood that content described in this section is not intended to identify key or important features in embodiments of the present disclosure, nor is it intended to limit the scope of the present disclosure. Other features of the present disclosure will be easily understood through the following description.

### BRIEF DESCRIPTION OF THE DRAWINGS

The accompanying drawings are used for better understanding of the solution and do not constitute a limitation to the present disclosure, in which:

FIG. 1 schematically shows a system architecture for a method and an apparatus of processing a speech information according to embodiments of the present disclosure;

FIG. 2 schematically shows a flowchart of a method of processing a speech information according to embodiments of the present disclosure;

FIG. 3 schematically shows a flowchart of a method of training a speech model according to embodiments of the present disclosure;

FIG. 4 schematically shows a network structure diagram of a keyword recognition model according to embodiments of the present disclosure;

FIG. 5 schematically shows a flowchart of a speech wake-up method according to embodiments of the present disclosure;

FIG. 6A schematically shows a network diagram of a first speech recognition model according to other embodiments of the present disclosure;

FIG. 6B schematically shows a network diagram of a second speech recognition model according to other embodiments of the present disclosure;

FIG. 6C schematically shows a network diagram of a third speech recognition model according to other embodiments of the present disclosure;

FIG. 7 schematically shows a block diagram of an apparatus of processing a speech information according to embodiments of the present disclosure;

FIG. 8 schematically shows a block diagram of an apparatus of training a speech model according to embodiments of the present disclosure;

FIG. 9 schematically shows a block diagram of a speech wake-up apparatus according to embodiments of the present disclosure; and

FIG. 10 schematically shows a block diagram of an electronic device suitable for implementing the method of processing the speech information according to embodiments of the present disclosure.

### DETAILED DESCRIPTION OF EMBODIMENTS

Exemplary embodiments of the present disclosure will be described below with reference to the accompanying drawings, which include various details of embodiments of the present disclosure to facilitate understanding and should be considered as merely exemplary. Therefore, those ordinary skilled in the art should realize that various changes and modifications may be made to embodiments described herein without departing from the scope and spirit of the present disclosure. Likewise, for clarity and conciseness, descriptions of well-known functions and structures are omitted in the following description.

The present disclosure provides a method and an apparatus of processing a speech information, a method and an apparatus of training a speech model, a speech wake-up method and apparatus, an electronic device, and a storage medium.

According to an aspect of the present disclosure, a method of processing a speech information is provided, including: performing a syllable recognition on a speech information to obtain a posterior probability sequence for the speech information, where the speech information includes a speech frame sequence, the posterior probability sequence corresponds to the speech frame sequence, and each posterior probability in the posterior probability sequence represents a similarity between a syllable in a speech frame matched with the posterior probability and a predetermined syllable; and determining a target peak speech frame from the speech frame sequence based on the posterior probability sequence.

It should be noted that in technical solutions of the present disclosure, a collection, a storage, a use, a processing, a transmission, a provision, a disclosure, an application and other processing of user personal information involved comply with provisions of relevant laws and regulations, take necessary security measures, and do not violate public order and good custom.

In the technical solutions of the present disclosure, the acquisition or collection of user personal information has been authorized or allowed by users.

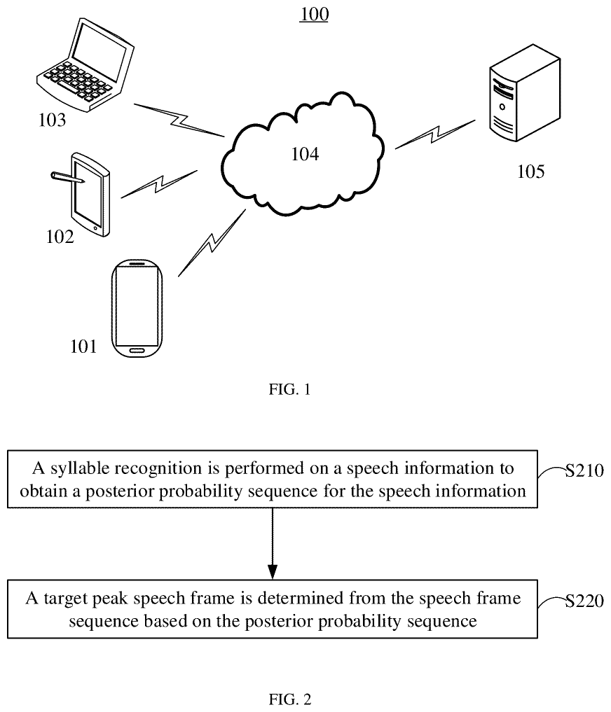

FIG. 1 schematically shows an exemplary system architecture to which a method and an apparatus of processing a speech information may be applied according to embodiments of the present disclosure.

It should be noted that FIG. 1 is merely an example of the system architecture to which embodiments of the present disclosure may be applied, so as to help those skilled in the art understand technical contents of the present disclosure. However, it does not mean that embodiments of the present disclosure may not be applied to other devices, systems, environments or scenarios. For example, in other embodiments, the exemplary system architecture to which the method and the apparatus of processing the speech information may include a terminal device, but the terminal device may implement the method and the apparatus of processing the speech information provided in embodiments of the present disclosure without interacting with a server.

As shown in FIG. 1, a system architecture 100 according to such embodiments may include terminal devices 101, 102 and 103, a network 104, and a server 105. The network 104 is a medium for providing a communication link between the terminal devices 101, 102, 103 and the server 105. The network 104 may include various connection types, such as wired and/or wireless communication links, or the like.

The terminal devices 101, 102 and 103 may be used by a user to interact with the server 105 through the network 104 to receive or send messages, etc. The terminal devices 101, 102 and 103 may be installed with various communication client applications, such as knowledge reading applications, web browser applications, search applications, instant messaging tools, email clients and/or social platform software, etc. (just for example).

The terminal devices 101, 102 and 103 may be various electronic devices having display screens and supporting web browsing, including but not limited to smart phones, tablet computers, laptop computers, desktop computers, or the like.

The server 105 may be a server that provides various services, such as a background management server (just for example) that provides a support for a content browsed by the user using the terminal devices 101, 102 and 103. The background management server may analyze and process a received user request and other data, and feed back a processing result (e.g., a webpage, information or data acquired or generated according to the user request) to the terminal devices.

It should be noted that the method of processing the speech information provided in embodiments of the present disclosure may generally be performed by the terminal device 101, 102 or 103. Accordingly, the apparatus of processing the speech information provided in embodiments of the present disclosure may also be arranged in the terminal device 101, 102 or 103.

Alternatively, the method of processing the speech information provided in embodiments of the present disclosure may generally be performed by the server 105. Accordingly, the apparatus of processing the speech information provided in embodiments of the present disclosure may be generally arranged in the server 105. The method of processing the speech information provided in embodiments of the present disclosure may also be performed by a server or server cluster different from the server 105 and capable of communicating with the terminal devices 101, 102, 103 and/or the server 105. Accordingly, the apparatus of processing the speech information provided in embodiments of the present disclosure may also be arranged in a server or server cluster different from the server 105 and capable of communicating with the terminal devices 101, 102, 103 and/or the server 105.

For example, the terminal device 101, 102 or 103 may acquire a speech information, and then send the acquired speech information to the server 105. The server 105 performs a syllable recognition on the speech information to obtain a posterior probability sequence for the speech information, and determine a target peak speech frame from the speech frame sequence based on the posterior probability sequence. Alternatively, a server or server cluster capable of communicating with the terminal devices 101, 102, 103 and/or the server 105 performs a syllable recognition on the speech information, and finally determines the target peak speech frame from the speech frame sequence.

It should be understood that the number of terminal devices, network and server shown in FIG. 1 are merely schematic. According to implementation needs, any number of terminal devices, networks and servers may be provided.

It should be noted that a sequence number of each operation in the following methods is merely used to represent the operation for ease of description, and should not be regarded as indicating an execution order of each operation. Unless explicitly stated, the methods do not need to be performed exactly in the order shown.

FIG. 2 schematically shows a flowchart of a method of processing a speech information according to embodiments of the present disclosure.

As shown in FIG. 2, the method includes operations S210 to S220.

In operation S210, a syllable recognition is performed on a speech information to obtain a posterior probability sequence for the speech information.

According to embodiments of the present disclosure, the speech information includes a speech frame sequence, and the posterior probability sequence corresponds to the speech frame sequence. Each posterior probability in the posterior probability sequence is used to represent a similarity between a syllable in a speech frame matched with the posterior probability and a predetermined syllable.

In operation S220, a target peak speech frame is determined from the speech frame sequence based on the posterior probability sequence.

According to embodiments of the present disclosure, the predetermined syllable may refer to a wake-up syllable, for example, a syllable corresponding to a wake-up word. The predetermined syllable is not limited in term of number, and there may be one or more syllables. The number of predetermined syllables may be determined according to a number of characters in the wake-up word.

According to embodiments of the present disclosure, determining the target peak speech frame from the speech frame sequence according to the posterior probability sequence may refer to: determining, according to the posterior probability sequence, a speech frame closest to the predetermined syllable from the speech frame sequence as the target peak speech frame.

According to embodiments of the present disclosure, by selecting the target peak speech frame from the speech frame sequence based on the posterior probability sequence, it is possible to remove a noise speech frame in the speech frame sequence and achieve an effect of noise reduction. In addition, compared with using the speech frame sequence as training data, using the target peak speech frame as the training data may reduce a redundancy of the training data and improve a training efficiency of model.

According to other embodiments of the present disclosure, performing the syllable recognition on the speech information to obtain the posterior probability sequence for the speech information in operation S210 shown in FIG. 2 may further include: performing a syllable feature extraction on the speech information to obtain a syllable feature matrix, and performing a linear transformation on the syllable feature matrix to obtain the posterior probability sequence corresponding to the speech frame sequence.

According to embodiments of the present disclosure, performing the syllable feature extraction on the speech information to obtain the syllable feature matrix may refer to: inputting the speech information into a syllable feature extraction model, so as to perform a syllable feature extraction and output the syllable feature matrix.

According to embodiments of the present disclosure, the syllable feature extraction model may include CNN (Convolutional Neural Networks), RNN (Recurrent Neural Network), GRU (Gate Recurrent Unit), or LSTM (Long Short-Term Memory), etc., or a combination thereof.

According to embodiments of the present disclosure, the linear transformation may be performed on the syllable feature matrix by using a fully connected layer and an activation function, so as to obtain the posterior probability sequence. The activation function may be a Softmax activation function, but it is not limited thereto, and may also be a Sigmoid activation function. A number of layers of the fully connected layer is not limited, which may be, for example, one layer or multiple layers.

According to embodiments of the present disclosure, a plurality of target peak speech frames may be determined. In a case of a plurality of target peak speech frames, a predetermined number of target posterior probabilities may be determined using a joint probability value. The predetermined number may refer to 2, 3 or more, which may be adjusted according to the number of characters in the actual wake-up word.

According to embodiments of the present disclosure, for example, if the wake-up word contains two Chinese characters, then two predetermined syllables correspond to the wake-up word, and two target peak speech frames may be determined.

According to other embodiments of the present disclosure, determining the target peak speech frame from the speech frame sequence based on the posterior probability sequence in operation S220 shown in FIG. 2 may further include: determining a predetermined number of target posterior probabilities from the posterior probability sequence, and determining the predetermined number of target peak speech frames corresponding to the predetermined number of target posterior probabilities from the speech frame sequence.

According to embodiments of the present disclosure, the predetermined number of target posterior probabilities may refer to those having a largest joint probability value. The joint probability value may refer to a probability value obtained by adding or multiplying the predetermined number of posterior probabilities. It should be noted that, in a case that the posterior probability is normalized data, which ranges from 0 to 1, the joint probability value may refer to a probability value obtained by adding the predetermined number of posterior probabilities. In addition, the joint probability value further contains a frame position information corresponding to the speech frame, that is, the joint probability value is a probability value obtained by adding or multiplying the predetermined number of posterior probabilities according to a predetermined speech frame position information. For example, in the speech information “ [symbol] (xiao)”, “ [symbol] (ming)”, “ [symbol] (ni)”, “ [symbol] (hao)” (Hello, Xiao Ming), a frame position of the speech frame corresponding to the syllable “ [symbol] ” precedes the frame position of the speech frame corresponding to the syllable “ [symbol] ”, and the frame position of the speech frame corresponding to the syllable “ [symbol] ” is between the two.

According to embodiments of the present disclosure, by determining the predetermined number of target posterior probabilities using the predetermined number of posterior probabilities having the largest joint probability value, it is possible to perform a further selection by using the frame position information of the speech frame while selecting the target peak speech frame from the posterior probability sequence by using the posterior probability value, so that the target peak speech frame may be determined more accurately.

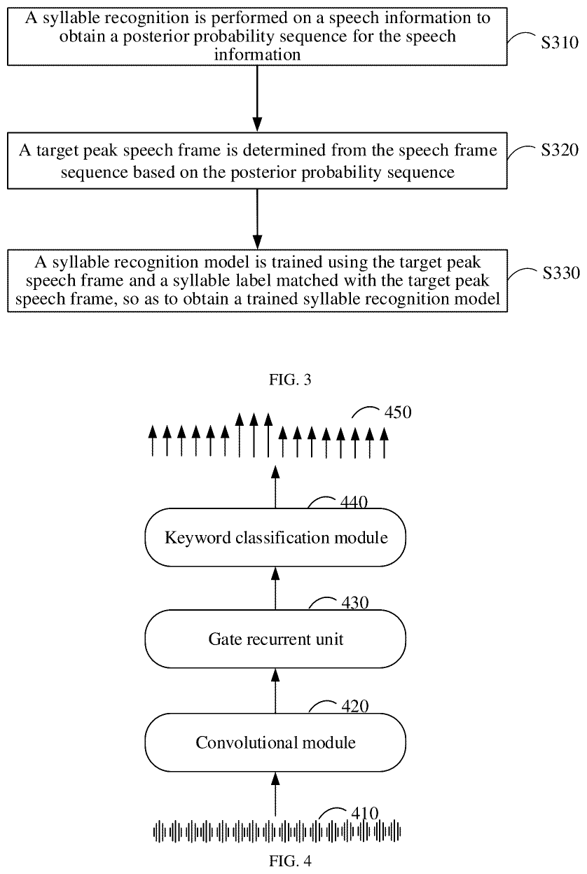

FIG. 3 schematically shows a flowchart of a method of training a speech model according to embodiments of the present disclosure.

As shown in FIG. 3, the method includes operations S310 to S330.

In operation S310, a syllable recognition is performed on a speech information to obtain a posterior probability sequence for the speech information.

According to embodiments of the present disclosure, the speech information includes a speech frame sequence, and the posterior probability sequence corresponds to the speech frame sequence. Each posterior probability in the posterior probability sequence is used to represent a similarity between a syllable in a speech frame matched with the posterior probability and a predetermined syllable.

In operation S320, a target peak speech frame is determined from the speech frame sequence based on the posterior probability sequence.

In operation S330, a syllable recognition model is trained using the target peak speech frame and a syllable label matched with the target peak speech frame, so as to obtain a trained syllable recognition model.

According to embodiments of the present disclosure, the target peak speech frame is obtained using the method of processing the speech information as shown in FIG. 2.

According to embodiments of the present disclosure, by training the syllable recognition model using the target peak speech frame and the syllable label matched with the target peak speech frame, it is possible to prevent the syllable recognition model from learning a feature of a noise speech frame in the speech frame sequence during the training process, so that the training efficiency and accuracy of the syllable recognition model may be improved.

According to other embodiments of the present disclosure, an initial model may be pre-trained by using an initial sample to obtain a pre-trained model, and the pre-trained model may be used as the syllable recognition model.

According to embodiments of the present disclosure, the initial sample may include a speech information such as a speech frame sequence, and a syllable label sequence corresponding to the speech frame sequence. Each speech frame in the speech frame sequence may be labeled using a forced alignment technology, so as to obtain the syllable label sequence corresponding to the speech frame sequence. The forced alignment may be performed on the speech frame sequence by using a labeling model, for example, the speech frame sequence may be input into the labeling model to obtain the syllable label sequence. A network of the labeling model is not limited, as long as it is a general syllable labeling model.

According to embodiments of the present disclosure, by using the pre-trained model as the syllable recognition model, the syllable recognition model may have a recognition ability, and then the optimization and training of the syllable recognition model using the target peak speech frame and the syllable label is efficient.

According to other embodiments of the present disclosure, the speech frame sequence may be processed using the syllable recognition model, so as to obtain the target peak speech frame as shown in FIG. 2. For example, the speech information is input into the syllable recognition model to obtain the posterior probability sequence for the speech information, and the target peak speech frames is determined from the speech frame sequence based on the posterior probability sequence.

According to embodiments of the present disclosure, the syllable recognition model includes a feature extraction and encoding module and a syllable classification module.

According to embodiments of the present disclosure, training the syllable recognition model using the target peak speech frame and the syllable label matched with the target peak speech frame to obtain the trained syllable recognition model may further include: inputting the target peak speech frame into the feature extraction and encoding module to obtain a syllable feature matrix; inputting the syllable feature matrix into the syllable classification module to obtain a sample syllable recognition result; and training the syllable recognition model by using the sample syllable recognition result and the syllable label, so as to obtain the trained syllable recognition model.

According to embodiments of the present disclosure, training the syllable recognition model using the sample syllable recognition result and the syllable label to obtain the trained syllable recognition model may include: inputting the sample syllable recognition result and the syllable label into a syllable loss function to obtain a syllable loss value; and adjusting a parameter of the syllable recognition model based on the syllable loss value until a predetermined training requirement is met. The predetermined training requirement may include at least one selected from: a convergence of the syllable loss value, a number of parameter adjustments reaching a predetermined number of rounds, or the sample syllable recognition result being close to the syllable label.

According to embodiments of the present disclosure, the syllable loss function may be trained using a cross-entropy loss function. However, the present disclosure is not limited to this, and any loss function matched with a network structure of the syllable recognition model may be used.

According to embodiments of the present disclosure, by training the syllable recognition model using the above-mentioned peak search method, it is possible to search a key speech frame of the speech information, improve the subsequent training efficiency and accuracy of the syllable recognition model, and avoid an ineffective training of the syllable recognition model caused by a noise speech frame.

According to embodiments of the present disclosure, the syllable classification module may include a fully connected layer and an activation function. The activation function may be a Softmax activation function, but it is not limited thereto, and may also be a Sigmoid activation function. The number of layers of the fully connected layer is not limited, which may be, for example, one layer or multiple layers.

According to embodiments of the present disclosure, the feature extraction and encoding module may be constructed using a network structure in a Conformer model (convolution augmentation-based encoder). However, the present disclosure is not limited to this, a Conformer module in the Conformer model may also be used, or a network structure obtained by performing lightweighting such as pruning on the Conformer model or the Conformer module may also be used.

According to embodiments of the present disclosure, the feature extraction and encoding module may include a feature extraction layer, a dimension reduction layer, and an encoding layer arranged in sequence.

According to embodiments of the present disclosure, the feature extraction layer may include at least one selected from: at least one relative sinusoidal positional encoding layer, at least one convolutional layer, or at least one feed forward layer (Feed Forward Module).

According to embodiments of the present disclosure, the encoding layer may include a Conformer module, which may include, for example, at least one selected from: a plurality of feed forward layers, at least one multi-headed attention mechanism layer (Multi-Headed Self-Attention module), or at least one convolutional layer.

According to embodiments of the present disclosure, the dimension reduction layer may include a mapping function. However, the present disclosure is not limited to this, and the dimension reduction layer may also include other layer structures for implementing a dimension reduction of a high-dimensional matrix to obtain a low-dimensional matrix.

According to embodiments of the present disclosure, inputting the target peak speech frame into the feature extraction and encoding module to obtain the syllable feature matrix may further include: inputting a speech to be recognized into the feature extraction layer to obtain a feature matrix; inputting the feature matrix into the dimension reduction layer to obtain a dimension-reduced feature matrix; and inputting the dimension-reduced feature matrix into the encoding layer to obtain the syllable feature matrix.

According to embodiments of the present disclosure, by using the dimension reduction layer, an amount of data input into the encoding layer may be reduced, and then an amount of calculation of the syllable recognition model may be reduced. In addition, a number of stacked layers of the encoding layer may also be reduced. For example, the number of stacked layers of the encoding layer may be determined to be any one of 1 to 4 according to a lightweight parameter quantity threshold.

According to embodiments of the present disclosure, by designing the dimension reduction layer in the speech recognition model and controlling the number of stacked layers of the encoding layer, it is possible to achieve the lightweight and miniaturization of the syllable recognition model while ensuring the recognition accuracy, so that the recognition efficiency may be improved, and an internal consumption of a processor of a terminal device may be reduced when the syllable recognition model is applied to the terminal device.

According to embodiments of the present disclosure, the speech recognition model may include a syllable recognition model. However, the present disclosure is not limited to this, and the speech recognition model may further include a keyword recognition model. The syllable recognition model and the keyword recognition model may be trained together, or the syllable recognition model and the keyword recognition model may be trained separately.

According to embodiments of the present disclosure, the keyword recognition model may be trained by using a keyword training sample to obtain a trained keyword recognition model. The speech recognition model may be obtained based on the trained syllable recognition model and the trained keyword recognition model.

According to embodiments of the present disclosure, the keyword training sample includes a training speech and a keyword label matched with the training speech. The training speech may be a speech information containing “ [symbol] (Hello, Xiao Ming)”. The keyword label matched with the training speech may be a label indicating whether the training speech contains a correct wake-up word. The keyword label may be represented by 0 or 1. 0 is used to represent a label that the training speech does not contain the correct wake-up word, and 1 is used to represent a label that the training speech contains the correct wake-up word.

According to embodiments of the present disclosure, training the keyword recognition model by using the keyword training sample so as to obtain the trained keyword recognition model may include: inputting the training speech into the keyword recognition model to obtain a keyword confidence sequence for the training speech; determining a target keyword confidence from the keyword confidence sequence; and training the keyword recognition model by using the target keyword confidence and the keyword label, so as to obtain the trained keyword recognition model.

According to embodiments of the present disclosure, the target keyword confidence in the keyword confidence sequence may refer to a confidence of a keyword speech frame related to a target keyword, i.e., the wake-up word. For example, the target keyword in the speech information “ [symbol] ” may be, for example, the wake-up word “ [symbol] [symbol] ”, and the keyword speech frame may include a plurality of speech frames between a 20^{th} speech frame and an 80^{th} speech frame. The target keyword confidence may be the confidence corresponding to any one of the plurality of keyword speech frames, for example, the confidence corresponding to a last one of the plurality of keyword speech frames, such as the confidence corresponding to the 80^{th} speech frame. However, the present disclosure is not limited to this, and the target keyword confidence may also be an average value of a plurality of confidences respectively corresponding to the plurality of keyword speech frames, as long as it is a confidence of the keyword speech frame related to the target keyword.

According to embodiments of the present disclosure, training the keyword recognition model by using the target keyword confidence and the keyword label may refer to: inputting the target keyword confidence and the keyword label into a keyword loss function to obtain a keyword loss value; and adjusting a parameter of the keyword recognition model based on the keyword loss value until a training requirement is met. The training requirement may include at least one selected from: reaching a predetermined number of training rounds, a convergence of the keyword loss value, or the target keyword confidence being close to the keyword label.

According to embodiments of the present disclosure, the keyword loss function may be a cross-entropy loss function, which is not limited here, as long as it is a loss function matched with a network structure of the keyword recognition model.

According to embodiments of the present disclosure, by training the keyword recognition model using the target keyword confidence and the keyword label, a boundary division of the keyword speech frame may be automatically performed by using the target keyword confidence, and it is not required to manually perform, for example, a boundary labeling on the training speech, so that a data processing efficiency may be improved. In this way, online sample mining may be achieved, and a collection cost for training speech may be reduced. In addition, by training the keyword recognition model using the target keyword confidence and the keyword label, a min-max-pooling training method may be achieved since the target keyword confidence is used to represent the confidence related to the keyword speech frame. Based on the target keyword confidence, it is possible to select a keyword speech frame most likely to cause wake-up in a positive sample from the training speech frame sequence, and select a keyword speech frame most likely to cause false positive in a negative sample from the training speech frame sequence, so as to train the keyword recognition model to learn a keyword speech feature most likely to cause wake-up and a keyword speech feature most likely to cause false positive, so that the trained keyword recognition model has a high accuracy and a low false positive rate.

FIG. 4 schematically shows a network structure diagram of a keyword recognition model according to embodiments of the present disclosure.

As shown in FIG. 4, the keyword recognition model includes a convolutional module, a gate recurrent unit and a keyword classification module arranged in sequence.

As shown in FIG. 4, inputting the training speech into the keyword recognition model to obtain the keyword confidence sequence for the training speech may further include: inputting the training speech 410 into the convolutional module 420 to obtain a first-level feature vector sequence; inputting the first-level feature vector sequence into the gate recurrent unit 430 to obtain a second-level feature vector sequence; and inputting the second-level feature vector sequence into the keyword classification module 440 to obtain the keyword confidence sequence 450.

According to embodiments of the present disclosure, the training speech includes a training speech frame sequence, and the first-level feature vector sequence corresponds to the training speech frame sequence.

According to embodiments of the present disclosure, the keyword recognition model is not limited to include one convolutional module, and may also include a plurality of stacked convolutional modules. Similarly, the keyword recognition model may also include a plurality of stacked gate recurrent units and a plurality of stacked keyword classification modules.

According to embodiments of the present disclosure, the convolutional module may include CNN (Convolutional Neural Networks).

According to embodiments of the present disclosure, the keyword classification module may include a fully connected layer and an activation function. The activation function may be a Softmax activation function. However, the present disclosure is not limited to this, and the activation function may also be a Sigmoid activation function. The number of layers of the fully connected layer is not limited, which may be, for example, one layer or multiple layers.

According to embodiments of the present disclosure, the gate recurrent unit is not limited to GRU (Gate Recurrent Unit), and may also be a GRU-derived module, for example, a GRU-derived module obtained by light-weighting GRU.

According to embodiments of the present disclosure, using the GRU-derived module, also known as a Projected Light-GRU module, it is more helpful to load the keyword recognition model on a terminal device such as a speech interaction device while ensuring a real-time performance of a wake-up word detection, that is, a lightweight deployment on the terminal side may be achieved.

According to other embodiments of the present disclosure, inputting the first-level feature vector sequence into the gate recurrent unit to obtain the second-level feature vector sequence includes repeatedly performing the following operations: determining an update gate of a current moment and a candidate hidden layer information of the current moment based on an output vector of a previous moment and an input vector of the current moment, where the input vector of the current moment is a first-level feature vector at the current moment in the first-level feature vector sequence; determining a hidden layer information of the current moment based on the candidate hidden layer information of the current moment, a hidden layer information of the previous moment and the update gate of the current moment; determining an output vector of the current moment based on the hidden layer information of the current moment and a predetermined parameter.

According to embodiments of the present disclosure, the output vector of the current moment is a second-level feature vector at the current moment in the second-level feature vector sequence. The predetermined parameter, also known as a projection parameter, is determined based on a lightweight parameter quantity threshold.

According to embodiments of the present disclosure, the lightweight parameter quantity threshold may refer to a parameter setting benchmark, such as a specified parameter quantity threshold. A size of the predetermined parameter is less than or equal to the lightweight parameter quantity threshold, so as to reduce a data processing amount of the keyword recognition model.

According to embodiments of the present disclosure, compared with a standard GRU, in the Projected Light-GRU module provided in embodiments of the present disclosure, a reset gate is removed, and the predetermined parameter is introduced, so that a calculation amount of the keyword recognition model is reduced. When a keyword recognition model including the Projected Light-GRU module is applied to a speech interaction device, a resource overhead may be reduced while ensuring a high performance, so that the keyword recognition model loaded in the speech interaction device may be in a running state around the clock, and a wake-up response speed of the speech interaction device may be improved.

According to embodiments of the present disclosure, the Projected Light-GRU module may be expressed by Equation (1) to Equation (4) as follows.

zₜ=σ(BN(w_{z}xₜ)+u_{z}oₜ₋₁) (1)

[symbol]

=g(BN(wₕxₜ)+uₕoₜ₋₁) (2)

hₜ=zₜ⊙hₜ₋₁+(1−zₜ) [symbol] (3)

oₜ=wₒhₜ (4)

where zₜ represents an update gate of a moment t, with a range of (0, 1); δ (·) represents a sigmoid function; g (·) represents a Gaussian error linear unit activation function (such as GELU activation function); BN (·) represents a normalization function; xₜ represents an input vector of the moment t; oₜ₋₁ represents an output vector of a moment (t−1); oₜ represents an output data of the moment t; w_{z} and u_{z} represent parameters related to the sigmoid function; wₕ and uₕ represent parameters related to the GELU activation function; hₜ₋₁ represents a hidden layer information of the moment (t−1); hₜ represents a hidden layer information of the moment t; wₒ represents a projection parameter; [symbol] represents a candidate hidden layer information of the moment t.

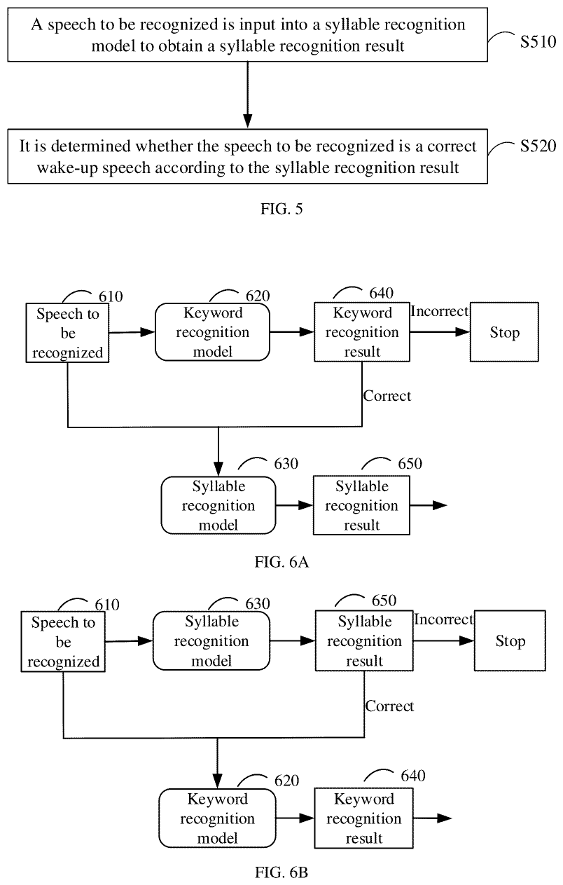

FIG. 5 schematically shows a flowchart of a speech wake-up method according to embodiments of the present disclosure.

As shown in FIG. 5, the method includes operations S510 to S520.

In operation S510, a speech to be recognized is input into a syllable recognition model to obtain a syllable recognition result.

In operation S520, it is determined whether the speech to be recognized is a correct wake-up speech according to the syllable recognition result.

According to embodiments of the present disclosure, the syllable recognition model is obtained by using the method of training the speech model provided in embodiments of the present disclosure. By using the above-mentioned training method, the syllable recognition model may have a high recognition accuracy and a low false positive rate.

According to embodiments of the present disclosure, the speech to be recognized may be issued by the user. When it is determined that the speech to be recognized is the correct wake-up speech according to the syllable recognition result, a response speech may be given to the user, and a subsequent human-computer interaction operation may be performed. When it is determined that the speech to be recognized is an incorrect wake-up speech according to the syllable recognition result, no response may be given.

According to other embodiments of the present disclosure, a network structure of the syllable recognition model may include a dimension reduction layer, so that a dimension-reduced feature matrix is input into the encoding layer, and then the subsequent data processing amount of the encoding layer may be reduced. In addition, the encoding layer may include a plurality of encoding layers connected in cascade. The number of layers of the encoding layer may be any one from 1 to 4, so that the network structure of the syllable recognition model may be reduced, and a lightweight processing may be achieved.

According to embodiments of the present disclosure, it is possible to achieve the lightweight and miniaturization of the syllable recognition model while ensuring the recognition accuracy by using the syllable recognition model provided in embodiments of the present disclosure, so that the recognition efficiency may be improved. Furthermore, when the syllable recognition model is applied to a terminal device, the internal consumption of the processor of the terminal device may be reduced.

According to embodiments of the present disclosure, the speech recognition model may also be used to perform the speech wake-up method provided in embodiments of the present disclosure. For example, the speech recognition model includes a syllable recognition model and a keyword recognition model.

According to embodiments of the present disclosure, the speech wake-up method may further include: inputting the speech to be recognized into the keyword recognition model to obtain a keyword recognition result.

According to embodiments of the present disclosure, determining whether the speech to be recognized is the correct wake-up speech according to the syllable recognition result may further include: determining whether the speech to be recognized is the correct wake-up speech according to the syllable recognition result and the keyword recognition result.

According to embodiments of the present disclosure, determining whether the speech to be recognized is the correct wake-up speech according to the syllable recognition result may refer to: determining that the speech to be recognized is the correct wake-up speech when it is determined that the speech to be recognized includes a speech containing a predetermined wake-up syllable according to the syllable recognition result; or determining that the speech to be recognized is the incorrect wake-up speech when it is determined that the speech to be recognized does not include a speech containing a predetermined wake-up syllable according to the syllable recognition result.

According to embodiments of the present disclosure, determining whether the speech to be recognized is the correct wake-up speech according to the keyword recognition result may refer to: determining that the speech to be recognized is the correct wake-up speech when it is determined that the speech to be recognized includes a speech containing a predetermined wake-up word according to the keyword recognition result; or determining that the speech to be recognized is an incorrect wake-up speech when it is determined that the speech to be recognized does not include a speech containing the predetermined wake-up word according to the keyword recognition result.

According to embodiments of the present disclosure, determining whether the speech to be recognized is the correct wake-up speech according to the syllable recognition result and the keyword recognition result may refer to: determining that the speech to be recognized is the correct wake-up speech when it is determined that the speech to be recognized is the correct wake-up speech according to the syllable recognition result and it is determined that the speech to be recognized is the correct wake-up speech according to the keyword recognition result; or it is determined that the speech to be recognized is an incorrect wake-up speech when it is determined that the speech to be recognized is the incorrect wake-up speech according to the syllable recognition result or according to the keyword recognition result.

According to embodiments of the present disclosure, a word unit recognition for the wake-up word may be performed on the speech to be recognized by using the keyword recognition model, and a character unit recognition for the wake-up word may be performed on the speech to be recognized by using the syllable recognition model, so that the recognition may be performed on both global and local aspects, and then the wake-up accuracy may be improved, and the wake-up false positive may be reduced.

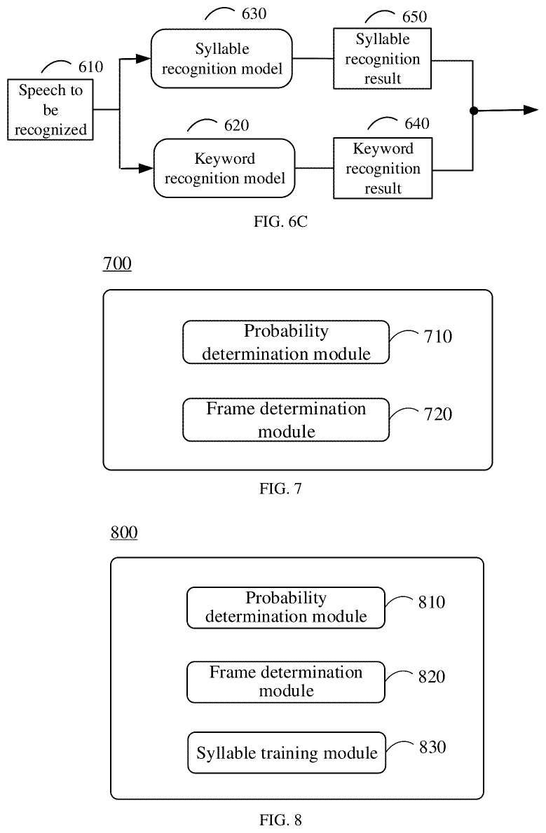

FIG. 6A schematically shows a network diagram of a first speech recognition model according to other embodiments of the present disclosure.

As shown in FIG. 6A, the first speech recognition model includes a keyword recognition model 620 and a syllable recognition model 630 arranged in sequence. A speech to be recognized 610 may be input into the keyword recognition model 620 to obtain a keyword recognition result 640. When it is determined that the speech to be recognized 610 is the correct wake-up speech based on the keyword recognition result, the speech to be recognized 610 is input into the syllable recognition model 630 to obtain a syllable recognition result 650. When it is determined that the speech to be recognized is the correct wake-up speech based on the syllable recognition result, it is determined that the speech to be recognized is the correct wake-up speech, and the speech interaction device is woken up for subsequent human-computer interaction. When it is determined that the speech to be recognized is an incorrect wake-up speech based on the keyword recognition result, the operation is stopped. When it is determined that the speech to be recognized is an incorrect wake-up speech based on the syllable recognition result, it is determined that the speech to be recognized is the incorrect wake-up speech, and the speech interaction device is not woken up.

FIG. 6B schematically shows a network diagram of a second speech recognition model according to other embodiments of the present disclosure.

As shown in FIG. 6B, the second speech recognition model includes a syllable recognition model 630 and a keyword recognition model 620 arranged in sequence. The speech to be recognized 610 may be input into the syllable recognition model 630 to obtain a syllable recognition result 650. When it is determined that the speech to be recognized 610 is the correct wake-up speech based on the syllable recognition result 650, the speech to be recognized 610 is input into the keyword recognition model 620 to obtain a keyword recognition result 640. When it is determined that the speech to be recognized 610 is the correct wake-up speech based on the keyword recognition result 640, it is determined that the speech to be recognized 610 is the correct wake-up speech, and the speech interaction device is woken up for subsequent human-computer interaction. When it is determined that the speech to be recognized is the incorrect wake-up speech based on the syllable recognition result, the operation is stopped. When it is determined that the speech to be recognized is an incorrect wake-up speech based on the keyword recognition result, it is determined that the speech to be recognized is an incorrect wake-up speech, and the speech interaction device is not woken up.

FIG. 6C schematically shows a network diagram of a third speech recognition model according to other embodiments of the present disclosure.

As shown in FIG. 6C, the third speech recognition model may include a keyword recognition model 620 and a syllable recognition model 630 arranged in parallel. The speech to be recognized 610 may be input into the keyword recognition model 620 to obtain a keyword recognition result 640. The speech to be recognized 610 is input into the syllable recognition model 620 to obtain a syllable recognition result 650. When it is determined that the speech to be recognized is the correct wake-up speech based on the keyword recognition result 640 and it is determined that the speech to be recognized is the correct wake-up speech based on the syllable recognition result 650, it is determined that the speech to be recognized 610 is the correct wake-up speech. When it is determined that the speech to be recognized is an incorrect wake-up speech based on the keyword recognition result or it is determined that the speech to be recognized is an incorrect wake-up speech based on the syllable recognition result, it is determined that the speech to be recognized 610 is an incorrect wake-up speech. When it is determined that the speech to be recognized is an incorrect wake-up speech based on the keyword recognition result and it is determined that the speech to be recognized is an incorrect wake-up speech based on the syllable recognition result, it is determined that the speech to be recognized is an incorrect wake-up speech.

According to embodiments of the present disclosure, the speech recognition model may be any one of the first speech recognition model, the second speech recognition model, and the third speech recognition model. The speech recognition model provided in embodiments of the present disclosure may be applied to a scenario where the number of wake-up words is reduced, and may reduce the false positive rate while ensuring the recognition accuracy in when the wake-up word include one word, two words, or three words.

According to embodiments of the present disclosure, compared with the second speech recognition model and the third speech recognition model, the first speech recognition model has characteristics of a simple network structure and a small amount of calculation of the keyword recognition model. In a case of a real-time activation state, the first speech recognition model may call the syllable recognition model to perform a syllable recognition operation on the speech to be recognized only when it is determined that the speech to be recognized is the correct wake-up speech based on the keyword recognition result output by the keyword recognition model, and may stop subsequent operations when it is determined that the speech to be recognized is an incorrect wake-up speech based on the keyword recognition result output by the keyword recognition model. In this way, the internal consumption of the speech interaction device as a terminal device may be reduced while ensuring the recognition accuracy.

FIG. 7 schematically shows a block diagram of an apparatus of processing a speech information according to embodiments of the present disclosure.

As shown in FIG. 7, an apparatus 700 of processing a speech information includes a probability determination module 710 and a frame determination module 720.

The probability determination module 710 is used to perform a syllable recognition on a speech information to obtain a posterior probability sequence for the speech information. The speech information includes a speech frame sequence, the posterior probability sequence corresponds to the speech frame sequence, and each posterior probability in the posterior probability sequence represents a similarity between a syllable in a speech frame matched with the posterior probability and a predetermined syllable.

The frame determination module 720 is used to determine a target peak speech frame from the speech frame sequence based on the posterior probability sequence.

According to embodiments of the present disclosure, the frame determination module includes a first determination sub-module and a second determination sub-module.

The first determination sub-module is used to determine a predetermined number of target posterior probabilities from the posterior probability sequence. The predetermined number of target posterior probabilities have a largest joint probability value.

The second determination sub-module is used to determine, from the speech frame sequence, the predetermined number of target peak speech frames corresponding to the predetermined number of target posterior probabilities.

According to embodiments of the present disclosure, the probability determination module includes an extraction sub-module and a transformation sub-module.

The extraction sub-module is used to perform a syllable feature extraction on the speech information to obtain a syllable feature matrix.

The transformation sub-module is used to perform a linear transformation on the syllable feature matrix to obtain the posterior probability sequence corresponding to the speech frame sequence.

FIG. 8 schematically shows a block diagram of an apparatus of training a speech model according to embodiments of the present disclosure.

As shown in FIG. 8, an apparatus 800 of training a speech model includes a probability determination module 810, a frame determination 820, and a syllable training module 830.

The probability determination module 810 is used to perform a syllable recognition on a speech information to obtain a posterior probability sequence for the speech information. The speech information includes a speech frame sequence, the posterior probability sequence corresponds to the speech frame sequence, and each posterior probability in the posterior probability sequence represents a similarity between a syllable in a speech frame matched with the posterior probability and a predetermined syllable.

The frame determination module 820 is used to determine a target peak speech frame from the speech frame sequence based on the posterior probability sequence.

The syllable training module 830 is used to train a syllable recognition model by using a target peak speech frame and a syllable label matched with the target peak speech frame, so as to obtain a trained syllable recognition model.

According to embodiments of the present disclosure, the target peak speech frame is obtained by using the apparatus of processing the speech information.

According to embodiments of the present disclosure, the apparatus of training the speech model further includes a word training module and a model determination module.

The word training module is used to train a keyword recognition model by using a keyword training sample, so as to obtain a trained keyword recognition model. The keyword training sample includes a training speech and a keyword label matched with the training speech.

The model determination module is used to obtain a speech recognition model based on the trained syllable recognition model and the trained keyword recognition model.

According to embodiments of the present disclosure, the word training module includes a first input sub-module, a third determination sub-module, and a word training sub-module.

The first input sub-module is used to input the training speech into the keyword recognition model to obtain a keyword confidence sequence for the training speech.

The third determination sub-module is used to determine a target keyword confidence from the keyword confidence sequence.

The word training sub-module is used to train the keyword recognition model by using the target keyword confidence and the keyword label, so as to obtain the trained keyword recognition model.

According to embodiments of the present disclosure, the keyword recognition model includes a convolutional module, a gate recurrent unit and a keyword classification module arranged in sequence.

According to embodiments of the present disclosure, the inputting sub-module includes a first input unit, a second input unit, and a third input unit.

The first input unit is used to input the training speech into the convolutional module to obtain a first-level feature vector sequence. The training speech includes a training speech frame sequence, and the first-level feature vector sequence corresponds to the training speech frame sequence.

The second input unit is used to input the first-level feature vector sequence into the gate recurrent unit to obtain a second-level feature vector sequence.

The third input unit is used to input the second-level feature vector sequence into the keyword classification module to obtain the keyword confidence sequence.

According to embodiments of the present disclosure, the second input unit includes the following repetitive sub-units.

A first determination sub-unit is used to determine an update gate of a current moment and a candidate hidden layer information of the current moment based on an output vector of a previous moment and an input vector of the current moment. The input vector of the current moment is a first-level feature vector at the current moment in the first-level feature vector sequence.

A second determination sub-unit is used to determine a hidden layer information of the current moment based on the candidate hidden layer information of the current moment, a hidden layer information of the previous moment, and the update gate of the current moment.

A third determination sub-unit is used to determine an output vector of the current moment based on the hidden layer information of the current moment and a predetermined parameter. The output vector of the current moment is a second-level feature vector at the current moment in the second-level feature vector sequence, and the predetermined parameter is determined based on a lightweight parameter quantity threshold.

According to embodiments of the present disclosure, the syllable recognition model includes a feature extraction and encoding module and a syllable classification module.

According to embodiments of the present disclosure, the syllable training module includes a second input sub-module, a third input sub-module, and a syllable training sub-module.

The second input sub-module is used to input the target peak speech frame into the feature extraction and encoding module to obtain a syllable feature matrix.

The third input sub-module is used to input the syllable feature matrix into the syllable classification module to obtain a sample syllable recognition result.

The syllable training sub-module is used to train the syllable recognition model by using the sample syllable recognition result and the syllable label, so as to obtain the trained syllable recognition model.

According to embodiments of the present disclosure, the feature extraction and encoding module includes a feature extraction layer, a dimension reduction layer and an encoding layer arranged in sequence.

According to embodiments of the present disclosure, the second inputting sub-module includes a fourth input unit, a fifth input unit, and a sixth input unit.

The fourth input unit is used to input the target peak speech frame into the feature extraction layer to obtain a feature matrix.

The fifth input unit is used to input the feature matrix into the dimension reduction layer to obtain a dimension-reduced feature matrix.

The sixth input unit is used to input the dimension-reduced feature matrix into the encoding layer to obtain the syllable feature matrix.

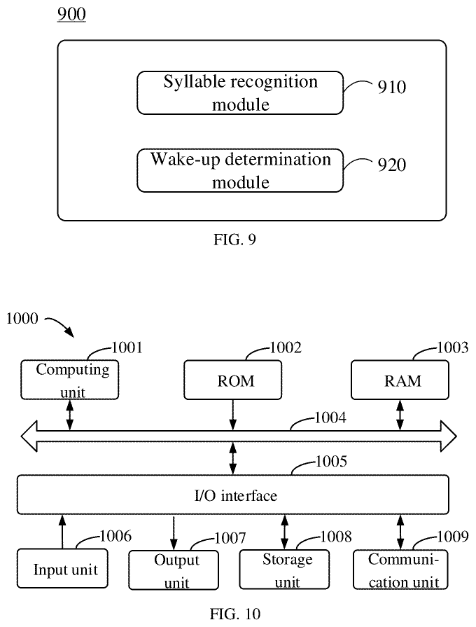

FIG. 9 schematically shows a block diagram of a speech wake-up apparatus according to embodiments of the present disclosure.

As shown in FIG. 9, a speech wake-up apparatus 900 includes a syllable recognition module 910 and a wake-up determination module 920.

The syllable recognition module 910 is used to input a speech to be recognized into a syllable recognition model to obtain a syllable recognition result.

The wake-up determination module 920 is used to determine whether the speech to be recognized is a correct wake-up speech according to the syllable recognition result.

According to embodiments of the present disclosure, the syllable recognition model is obtained by using the apparatus of training the speech model.

According to embodiments of the present disclosure, the speech wake-up apparatus further includes a word recognition module.

The word recognition module is used to input the speech to be recognized into a keyword recognition model to obtain a keyword recognition result.

According to embodiments of the present disclosure, the wake-up determination module includes a wake-up determination sub-module.

The wake-up determination sub-module is used to determine whether the speech to be recognized is the correct wake-up speech according to the syllable recognition result and the keyword recognition result.

According to embodiments of the present disclosure, the present disclosure further provides an electronic device, a readable storage medium, and a computer program product.

According to embodiments of the present disclosure, an electronic device is provided, including: at least one processor; and a memory communicatively connected to the at least one processor. The memory stores instructions executable by the at least one processor, and the instructions, when executed by the at least one processor, cause the at least one processor to implement the methods described in embodiments of the present disclosure.

According to embodiments of the present disclosure, a non-transitory computer-readable storage medium having computer instructions therein is provided, and the computer instructions are used to cause a computer to implement the methods described in embodiments of the present disclosure.

According to embodiments of the present disclosure, a computer program product containing a computer program is provided, and the computer program, when executed by a processor, causes the processor to implement the methods described in embodiments of the present disclosure.

FIG. 10 shows a schematic block diagram of an example electronic device 1000 for implementing embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 10, the electronic device 1000 includes a computing unit 1001 which may perform various appropriate actions and processes according to a computer program stored in a read only memory (ROM) 1002 or a computer program loaded from a storage unit 1008 into a random access memory (RAM) 1003. In the RAM 1003, various programs and data necessary for an operation of the electronic device 1000 may also be stored. The computing unit 1001, the ROM 1002 and the RAM 1003 are connected to each other through a bus 1004. An input/output (I/O) interface 1005 is also connected to the bus 1004.

A plurality of components in the electronic device 1000 are connected to the I/O interface 1005, including: an input unit 1006, such as a keyboard, or a mouse; an output unit 1007, such as displays or speakers of various types; a storage unit 1008, such as a disk, or an optical disc; and a communication unit 1009, such as a network card, a modem, or a wireless communication transceiver. The communication unit 1009 allows the electronic device 1000 to exchange information/data with other devices through a computer network such as Internet and/or various telecommunication networks.

The computing unit 1001 may be various general-purpose and/or dedicated processing assemblies having processing and computing capabilities. Some examples of the computing units 1001 include, but are not limited to, a central processing unit (CPU), a graphics processing unit (GPU), various dedicated artificial intelligence (AI) computing chips, various computing units that run machine learning model algorithms, a digital signal processing processor (DSP), and any suitable processor, controller, microcontroller, etc. The computing unit 1001 executes various methods and processes described above, such as the method of processing the speech information, the method of training the speech model, and the speech wake-up method. For example, in some embodiments, the method of processing the speech information, the method of training the speech model, and the speech wake-up method may be implemented as a computer software program which is tangibly embodied in a machine-readable medium, such as the storage unit 1008. In some embodiments, the computer program may be partially or entirely loaded and/or installed in the electronic device 1000 via the ROM 1002 and/or the communication unit 1009. The computer program, when loaded in the RAM 1003 and executed by the computing unit 1001, may execute one or more steps in the method of processing the speech information, the method of training the speech model, and the speech wake-up method described above. Alternatively, in other embodiments, the computing unit 1001 may be used to perform the method of processing the speech information, the method of training the speech model, and the speech wake-up method by any other suitable means (e.g., by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from a storage system, at least one input device and at least one output device, and may transmit the data and instructions to the storage system, the at least one input device, and the at least one output device.

Program codes for implementing the methods of the present disclosure may be written in one programming language or any combination of more programming languages. These program codes may be provided to a processor or controller of a general-purpose computer, a dedicated computer or other programmable data processing apparatus, such that the program codes, when executed by the processor or controller, cause the functions/operations specified in the flowcharts and/or block diagrams to be implemented. The program codes may be executed entirely on a machine, partially on a machine, partially on a machine and partially on a remote machine as a stand-alone software package or entirely on a remote machine or server.

In the context of the present disclosure, a machine-readable medium may be a tangible medium that may contain or store a program for use by or in connection with an instruction execution system, an apparatus or a device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a random access memory (RAM), a read only memory (ROM), an erasable programmable read only memory (EPROM or a flash memory), an optical fiber, a compact disk read only memory (CD-ROM), an optical storage device, a magnetic storage device, or any suitable combination of the above.

In order to provide interaction with the user, the systems and technologies described here may be implemented on a computer including a display device (for example, a CRT (cathode ray tube) or LCD (liquid crystal display) monitor) for displaying information to the user, and a keyboard and a pointing device (for example, a mouse or a trackball) through which the user may provide the input to the computer. Other types of devices may also be used to provide interaction with the user. For example, a feedback provided to the user may be any form of sensory feedback (for example, visual feedback, auditory feedback, or tactile feedback), and the input from the user may be received in any form (including acoustic input, speech input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and the Internet.

The computer system may include a client and a server. The client and the server are generally far away from each other and usually interact through a communication network. A relationship between the client and the server is generated through computer programs running on the corresponding computers and having a client-server relationship with each other. The server may be a cloud server, also known as a cloud computing server or a cloud host, which is a host product in a cloud computing service system to solve shortcomings of difficult management and weak service scalability existing in a conventional physical host and VPS (Virtual Private Server) service. The server may also be a server of a distributed system or a server combined with a block-chain.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. A method of processing a speech information, comprising:
performing a syllable recognition on a speech information to obtain a posterior probability sequence for the speech information, wherein the speech information comprises a speech frame sequence, the posterior probability sequence corresponds to the speech frame sequence, and each posterior probability in the posterior probability sequence represents a similarity between a syllable in a speech frame matched with the posterior probability and a predetermined syllable; and
determining a target peak speech frame from the speech frame sequence based on the posterior probability sequence.

2. The method according to claim 1, wherein the determining a target peak speech frame from the speech frame sequence based on the posterior probability sequence comprises:
determining a predetermined number of target posterior probabilities from the posterior probability sequence, wherein the predetermined number of target posterior probabilities have a largest joint probability value; and
determining, from the speech frame sequence, the predetermined number of target peak speech frames corresponding to the predetermined number of target posterior probabilities.

3. The method according to claim 1, wherein the performing a syllable recognition on a speech information to obtain a posterior probability sequence for the speech information comprises:
performing a syllable feature extraction on the speech information to obtain a syllable feature matrix; and
performing a linear transformation on the syllable feature matrix to obtain the posterior probability sequence corresponding to the speech frame sequence.

4. A method of training a speech model, comprising:
training a syllable recognition model by using a target peak speech frame and a syllable label matched with the target peak speech frame, so as to obtain a trained syllable recognition model,
wherein the target peak speech frame is obtained by using the method of processing the speech information of claim 1.

5. The method according to claim 4, further comprising:
training a keyword recognition model by using a keyword training sample, so as to obtain a trained keyword recognition model, wherein the keyword training sample comprises a training speech and a keyword label matched with the training speech; and
obtaining a speech recognition model based on the trained syllable recognition model and the trained keyword recognition model.

6. The method according to claim 5, wherein the training a keyword recognition model by using a keyword training sample to obtain a trained keyword recognition model comprises:
inputting the training speech into the keyword recognition model to obtain a keyword confidence sequence for the training speech;
determining a target keyword confidence from the keyword confidence sequence; and
training the keyword recognition model by using the target keyword confidence and the keyword label, so as to obtain the trained keyword recognition model.

7. The method according to claim 6, wherein the keyword recognition model comprises a convolutional module, a gate recurrent unit and a keyword classification module arranged in sequence; and
wherein the inputting the training speech into the keyword recognition model to obtain a keyword confidence sequence for the training speech comprises:
inputting the training speech into the convolutional module to obtain a first-level feature vector sequence, wherein the training speech comprises a training speech frame sequence, and the first-level feature vector sequence corresponds to the training speech frame sequence;
inputting the first-level feature vector sequence into the gate recurrent unit to obtain a second-level feature vector sequence; and
inputting the second-level feature vector sequence into the keyword classification module to obtain the keyword confidence sequence.

8. The method according to claim 7, wherein the inputting the first-level feature vector sequence into the gate recurrent unit to obtain a second-level feature vector sequence comprises repeatedly performing an operation comprising:
determining an update gate of a current moment and a candidate hidden layer information of the current moment based on an output vector of a previous moment and an input vector of the current moment, wherein the input vector of the current moment is a first-level feature vector at the current moment in the first-level feature vector sequence;
determining a hidden layer information of the current moment based on the candidate hidden layer information of the current moment, a hidden layer information of the previous moment, and the update gate of the current moment; and
determining an output vector of the current moment based on the hidden layer information of the current moment and a predetermined parameter, wherein the output vector of the current moment is a second-level feature vector at the current moment in the second-level feature vector sequence, and the predetermined parameter is determined based on a lightweight parameter quantity threshold.

9. The method according to claim 4, wherein the syllable recognition model comprises a feature extraction and encoding module and a syllable classification module; and
wherein the training a syllable recognition model by using a target peak speech frame and a syllable label matched with the target peak speech frame to obtain a trained syllable recognition model comprises:
inputting the target peak speech frame into the feature extraction and encoding module to obtain a syllable feature matrix;
inputting the syllable feature matrix into the syllable classification module to obtain a sample syllable recognition result; and
training the syllable recognition model by using the sample syllable recognition result and the syllable label, so as to obtain the trained syllable recognition model.

10. The method according to claim 9, wherein the feature extraction and encoding module comprises a feature extraction layer, a dimension reduction layer and an encoding layer arranged in sequence; and
wherein the inputting the target peak speech frame into the feature extraction and encoding module to obtain a syllable feature matrix comprises:
inputting the target peak speech frame into the feature extraction layer to obtain a feature matrix;
inputting the feature matrix into the dimension reduction layer to obtain a dimension-reduced feature matrix; and
inputting the dimension-reduced feature matrix into the encoding layer to obtain the syllable feature matrix.

11. A speech wake-up method, comprising:
inputting a speech to be recognized into a syllable recognition model to obtain a syllable recognition result; and
determining whether the speech to be recognized is a correct wake-up speech according to the syllable recognition result,
wherein the syllable recognition model is obtained by using the method of training the speech model of claim 4.

12. The method according to claim 11, further comprising:
inputting the speech to be recognized into a keyword recognition model to obtain a keyword recognition result;
wherein the determining whether the speech to be recognized is a correct wake-up speech according to the syllable recognition result comprises:
determining whether the speech to be recognized is the correct wake-up speech according to the syllable recognition result and the keyword recognition result.

13. An electronic device, comprising:
at least one processor; and
a memory communicatively connected to the at least one processor, wherein the memory stores instructions executable by the at least one processor, and the instructions, when executed by the at least one processor, cause the at least one processor to:
perform a syllable recognition on a speech information to obtain a posterior probability sequence for the speech information, wherein the speech information comprises a speech frame sequence, the posterior probability sequence corresponds to the speech frame sequence, and each posterior probability in the posterior probability sequence represents a similarity between a syllable in a speech frame matched with the posterior probability and a predetermined syllable; and
determine a target peak speech frame from the speech frame sequence based on the posterior probability sequence.

14. The electronic device according to claim 13, wherein the at least one processor is further configured for:
determining a predetermined number of target posterior probabilities from the posterior probability sequence, wherein the predetermined number of target posterior probabilities have a largest joint probability value; and
determining, from the speech frame sequence, the predetermined number of target peak speech frames corresponding to the predetermined number of target posterior probabilities.

15. The electronic device according to claim 13, wherein the at least one processor is further configured for:
performing a syllable feature extraction on the speech information to obtain a syllable feature matrix; and
performing a linear transformation on the syllable feature matrix to obtain the posterior probability sequence corresponding to the speech frame sequence.

16. An electronic device, comprising:
at least one processor; and
a memory communicatively connected to the at least one processor, wherein the memory stores instructions executable by the at least one processor, and the instructions, when executed by the at least one processor, cause the at least one processor to:
train a syllable recognition model by using a target peak speech frame and a syllable label matched with the target peak speech frame, so as to obtain a trained syllable recognition model,
wherein the target peak speech frame is obtained by using the electronic device of claim 13.

17. An electronic device, comprising:
at least one processor; and
a memory communicatively connected to the at least one processor, wherein the memory stores instructions executable by the at least one processor, and the instructions, when executed by the at least one processor, cause the at least one processor to:
input a speech to be recognized into a syllable recognition model to obtain a syllable recognition result; and
determine whether the speech to be recognized is a correct wake-up speech according to the syllable recognition result,
wherein the syllable recognition model is obtained by using the electronic device of claim 16.

18. A non-transitory computer-readable storage medium having computer instructions therein, wherein the computer instructions are configured to cause a computer to:
perform a syllable recognition on a speech information to obtain a posterior probability sequence for the speech information, wherein the speech information comprises a speech frame sequence, the posterior probability sequence corresponds to the speech frame sequence, and each posterior probability in the posterior probability sequence represents a similarity between a syllable in a speech frame matched with the posterior probability and a predetermined syllable; and
determine a target peak speech frame from the speech frame sequence based on the posterior probability sequence.

19. A non-transitory computer-readable storage medium having computer instructions therein, wherein the computer instructions are configured to cause a computer to:
train a syllable recognition model by using a target peak speech frame and a syllable label matched with the target peak speech frame, so as to obtain a trained syllable recognition model,
wherein the target peak speech frame is obtained by using the non-transitory computer-readable storage medium of claim 18.

20. A non-transitory computer-readable storage medium having computer instructions therein, wherein the computer instructions are configured to cause a computer to:
input a speech to be recognized into a syllable recognition model to obtain a syllable recognition result; and
determine whether the speech to be recognized is a correct wake-up speech according to the syllable recognition result,
wherein the syllable recognition model is obtained by using the non-transitory computer-readable storage medium of claim 19.
